(19) United States
(12) Patent Application Publication
(10) Pub. No.: US 2011/0057769 A1
(43) Pub. Date: Mar. 10, 2011

(54) Key switch for installation in a drive device and method for operating the key switch

(76) Inventor: Hugo Felder, Buchrain (CH)

(21) Appl. No.: 12/734,767

(22) PCT Filed: Nov. 20, 2008
(86) PCT No.: PCT/EP2008/065894

§ 371 Date: Nov. 18, 2010

(30) Foreign Application Priority Data
Nov. 23, 2007 (EP) 07121464.7

(51) Int. Cl. G06F 7/04

(52) U.S. Cl. 340/5.2

(57) ABSTRACT

The invention relates to key switches (15) for drive devices having key recognition means (30) for recognizing a key (13) having key bit (13.1) and having a key receptacle for inserting the key bit (13.1). The key recognition means (30) operate without contact and have corresponding scanning means (32) for scanning at least part of the key bit (13.1). The scanning means (32) deliver actual values of a key (13). Storage means (31) are provided in order to store comparison values of a key (13) in an initialization phase. An electronic comparator (33) is provided, which compares actual values to comparison values and causes a release if the actual values and comparison values agree.

The invention relates to a key switch according to the precharacterizing clause of claim 1, which is designed to be installed in an elevator cabin of an elevator system for example, and to a method, according to the precharacterizing clause of claim 14, for initializing a drive device using such a key switch.

Drive devices, such as elevator systems, moving walkways and escalators, are often provided with key switches.

In some countries, there are regulations which stipulate that an elevator cabin must be able to be operated by the fire department using a special key in the event of an emergency (for example when there is a fire). The elevator controller can be changed over to a special mode (emergency mode), for example, using this key.

Other drive devices in turn have key switches which are operated by service staff in order to be able to change over from normal operation to a service mode.

Drive devices which are controlled using key switches are also known. For example, a penthouse apartment can be reached with the elevator if a key switch was previously operated with the corresponding key.

Key switches are often very expensive especially since there is often the desire to be able to operate the elevator with the same key as the front door. If a plurality of people require a key, the entire key system has to be correspondingly planned and designed using a locking plan.

Another disadvantage of the previous key switches of this type is that the elevator system is more expensive as a result of the use of identical key switches at a plurality of points. Even if the elevator system has to be modified, for example because keys have been lost, all key switches have to be replaced with identical new key switches.

If a plurality of functions have to be able to be controlled by key switches nowadays, one key switch has to be installed for each function, which requires a very large amount of space. In addition to the costs, another point also plays an important role. The key switches typically have a cylinder which has a certain overall depth on account of the electromechanical elements. An analysis of existing key switches has revealed that this depth is between 50 and 60 mm (sometimes up to 90 mm). However, only a small overall depth is available in drive devices in particular. The large overall depth is also rather disruptive in solutions which have to satisfy aesthetic demands.

Therefore, the object of the invention is to provide a key switch which is more convenient to produce and can be used in a flexible manner and whose installation depth is smaller than in conventional solutions.

Nevertheless, an at least equivalent degree of security to that in previous apparatuses should be provided. In addition, the apparatus is intended to comply with the corresponding local rules and regulations.

The invention should also temporally restrict release for a function. For example, the cleaning staff may be allowed access only from 16:00 to 22:00.

The object is achieved by means of the features of claim 1 and by means of the features of claim 14. Advantageous exemplary embodiments and developments of the invention are outlined by the dependent patent claims.

The key switch according to the invention is distinguished by the fact that it has key recognition means for recognizing a key with a key bit and a key receptacle for inserting, guiding and positioning the key bit. The key recognition means operate contactlessly and scan at least one part of the key bit which has been inserted into the key receptacle. The corresponding scanning means provide actual values for a key which is currently inserted in the key receptacle. Memory means are provided in order to store comparison values for a key in an initialization phase. An electronic comparator is provided, which comparator compares actual values with comparison values and effects release if the actual values and comparison values match.

The method according to the invention is distinguished by the fact that, in order to initialize a drive device using a key switch having key recognition means for recognizing a key with a key bit and having a key receptacle for inserting the key bit into the key receptacle, the following steps are carried out:
the key bit of the key is inserted into the key receptacle,
at least one part of the key bit is contactlessly scanned and an actual value is provided for the key which is currently inserted in the key receptacle,
the actual value is compared with one or more comparison values which are stored in a memory,
   release is effected.

Thanks to the novel invention, a new key switch need not be used in the cabin if the elevator system has to be modified since only one new key can be stored with the novel invention.

If a plurality of functions have to be able to be controlled by key switches, only one central unit for all functions is required with the invention.

As a further advantage, mechanical lock opening tools (also burglary tools) which are customary nowadays become ineffective since their mechanical shape, configuration and method of operation are reliably recognized by the key recognition means according to the invention and do not effect release.

Further details and advantages of the invention are described below using exemplary embodiments and with reference to the drawings, in which:

FIG. 1 shows a simplified diagrammatic illustration of a part of a control panel with a key switch according to the invention;

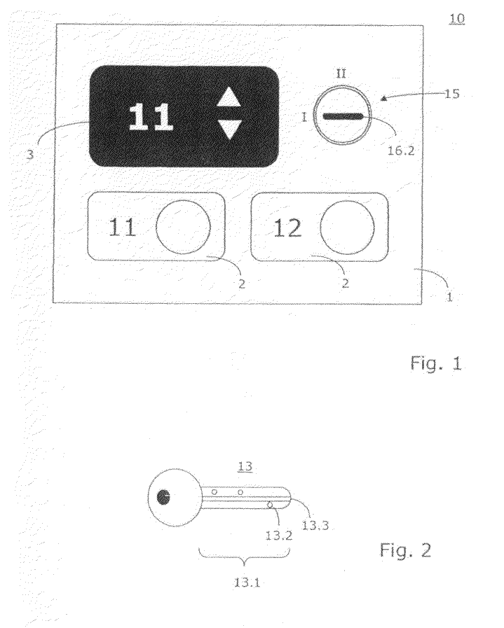

FIG. 2 shows a mechanical key with a key bit;

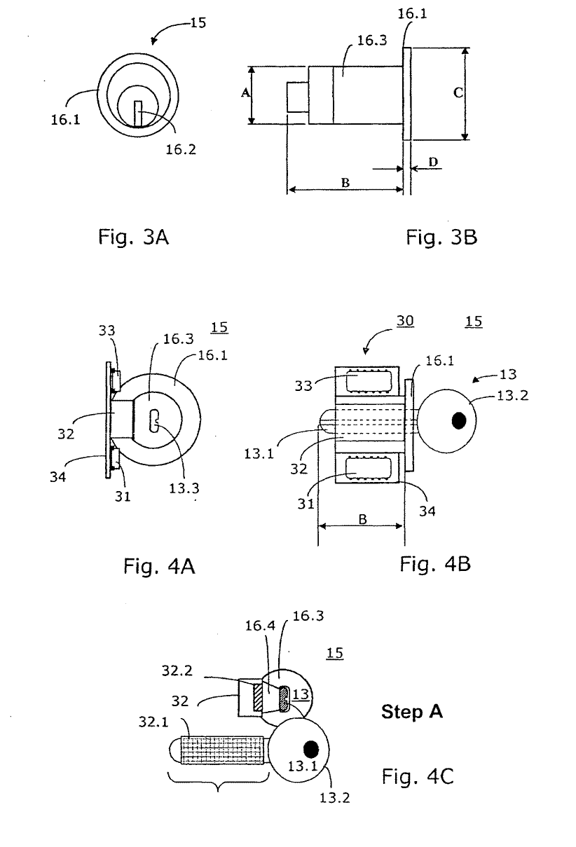

FIG. 3A shows a plan view of a conventional key cylinder;

FIG. 3B shows a side view of the conventional key cylinder according to FIG. 3A;

FIG. 4A shows a rear view of a key switch according to the invention;

FIG. 4B shows a side view of the key switch according to the invention according to FIG. 4A;

FIG. 4C shows a diagrammatic sectional view of the key switch according to the invention according to FIG. 4A;

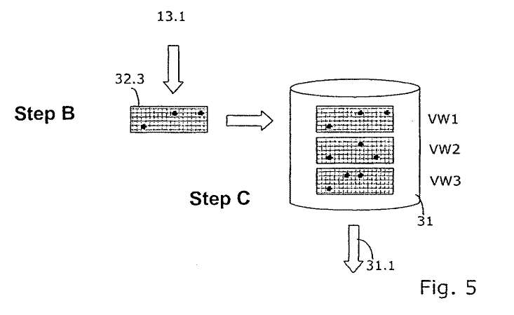

FIG. 5 shows a diagrammatic sequence of a method according to the invention.

As already indicated at the outset, the present patent application relates to key switches as are used in elevator systems, in escalators or in moving walkways. The key switch denotes a system or a unit which allows a particular group of people, for example fire department employees, the police, tenants or the like, to transfer the drive device to a desired mode, for example an emergency mode) or to trigger a special journey, for example. A mechanical key which is also referred to as a key here is used for this purpose. The invention can also be used with intelligent keys as long as these keys contain a key bit having recognizable features which distinguish the key from other keys.

FIG. 2 shows a simplified illustration of such a key 13. The invention relates to mechanical keys 13 or intelligent keys (for example with an installed chip) which have a key bit which are configured in such a manner that they mechanically interact with mating elements of a key cylinder as soon as the bit 13.1 of the key 13 is inserted into a key receptacle 16.2 of the key cylinder 16.3. An action can be triggered only when the “correct” key 13 is inserted. The triggering of an action is generally referred to as release in this case since release is effected only when a permitted key 13 has been recognized. Release is therefore not effected without the correct key.

Mechanical features, for example small depressions 13.2 and/or grooves 13.3, may be provided on the key bit 13.1. However, the key bit 13.1 can also have one or two comb-like edge(s), as is often conventional.

Details of the invention are now described using an exemplary embodiment which is shown in FIGS. 1 and 4A to 4C.

FIG. 1 shows a key switch 15 according to the invention as part of a control panel 1. The key switch 15 usually sits behind a covering plate of the control panel 1. The control panel 1 may have a number of operating elements 2 and may be provided with a display 3.

However, the key switch 15 may also be arranged at another location in an elevator cabin and/or outside the elevator cabin, for example beside shaft doors.

According to the invention, a key switch 15 having key recognition means for recognizing a key 13 with a key bit 13.1 is fitted in the elevator cabin. The key switch 15 comprises a key receptacle 16.2 for inserting the key bit 13.1. According to the invention, the key recognition means 30 operate contactlessly and have, for this reason, corresponding scanning means 32 for scanning at least one part of the key bit 13.1 which has been inserted into the key receptacle 16.2. The scanning means 32 provide actual values for a key 13 which is currently inserted in the key receptacle 16.2. A corresponding state is shown in FIGS. 4A and 4B. Memory means 31 are provided in order to store comparison values for a key 13 in an initialization phase. An electronic comparator 33 is also provided, which comparator compares actual values with comparison values and effects release if the actual values and comparison values match.

FIGS. 4A, 4B and 4C show a first embodiment of the invention. This is a simplified illustration in order to be able to explain the principle of the invention.

FIGS. 4A and 4B have been arranged in such a manner that they can be compared with FIGS. 3A and 3B which show a conventional key switch. This comparison reveals that the key switch 15 shown in FIG. 4B has a considerably smaller installation depth B than the key switch in FIG. 3B. In FIGS. 4A, 4B and 4C, an arrangement of the elements of the key switch 15 whose overall depth is even somewhat shorter than the length of the key bit 13.1 was selected. FIG. 4B reveals that the key bit 13.1 penetrates the key switch 15 and the end of the key bit 13.1 protrudes.

The elements of the key switch 15 according to the invention are described in more detail below. FIG. 4B reveals that the key 13 has been inserted into the key switch 15 from the right through a covering plate 16.1. Like in conventional key switches as well, the novel key switch has a type of key cylinder 16.3 or receiving body (referred to as key cylinder below for the sake of simplicity). However, unlike in a conventional key switch, this key cylinder 16.3 does not comprise any actual mechanical locking means. Since the invention operates contactlessly, the key 13 is simply inserted and need not necessarily be rotated. However, it may also be the case that the key can be rotated; rotation of a key makes it possible to scan a plurality of sides of, the key without increasing the detection effort and thus makes it possible to increase the security (it is not possible to copy a key). In this case, it is noted that, in one preferred embodiment, in addition to the contactless recognition of the key 13, simple mechanical recognition may also be provided in order to allow only certain types of keys.

The key cylinder 16.3 has a window 16.4 which is indicated in FIG. 4C. The term window is selected in this case in order to show that there is a “visual or operative connection” between a scanning means 32 and that part of the key bit 13.1 which is to be scanned. In the case of optical scanning, it is a (transparent) window with defined optical properties or an opening. If another form or a combination of different forms of contactless scanning is carried out, the window is configured in a correspondingly different manner. In the case of capacitive or inductive scanning, for example, the window may comprise a corresponding material (for example dielectric material).

FIGS. 4A to 4C reveal how the individual elements may be arranged. For example, a printed circuit board 34 or another carrier material may be used in order to accommodate the electronic components of the key recognition means 30. FIGS. 4A and 4B show that the printed circuit board 34 sits beside the key cylinder 16.3. The actual scanning means 32 for scanning at least one part of the key bit 13.1 which has been inserted into the key receptacle 16.2 are centrally located. The scanning means 32 are permanently connected to the key cylinder 16.3 and, via the window 16.4, have access to that region of the key bit 13.1 which is to be scanned. The other components (for example a memory chip which is used as the memory means 31 and an electronic comparator 33) may also be provided on the printed circuit board 34. FIGS. 4A and 4B show these components in the form of integrated circuits (ICs). However, discrete solutions or solutions which are completely integrated in an IC are also possible.

FIG. 4A reveals that the key cylinder 16.3 has a flat portion (secant through the circumference of the key cylinder 16.3) on the left. The scanning means 32 is fastened or arranged in the region of this flat portion. FIG. 4C shows that the window 16.4 extends from the flattened side of the key cylinder 16.3 to the region in which the key bit 13.1 is located.

FIG. 4C indicates that a camera element (optical detection element) 32.1 (for example a CCD chip), for example, can sit inside the scanning means 32. This camera element 32.1 generates an image or a recording of that region of the key bit 13.1 which is to be scanned. The corresponding signals or digital values provided by the camera element 32.1 are generally referred to as actual values in this case. These actual values may be transferred to the electronic comparator 33 via a cable or another connection, which comparator compares this actual value with one or more comparison values stored in the memory means 31. If the actual value matches one of the comparison values, the key recognition means 30 effect release. A special journey (for example to a protected area of the office) or an emergency mode, for example, can be triggered by this release.

In order to prepare the key recognition means 30 for use, at least the comparison value for a key 13 is predefined and stored in a so-called initialization phase. Release is effected after scanning and comparison only when the same key 13 or a copy of this key 13 is used after the initialization phase.

The inventive principle of contactlessly scanning (recognizing) a key 13 is described in FIG. 5 using an exemplary embodiment which operates with a CCD chip as the camera element 32.1. Step A shows the key and the pixel array of the camera element 32.1 with a large number of pixels arranged in rows and columns. The camera element 32.1 now records an electronic (digital) image 32.3 of the key bit 13.1. This image is shown as step B in FIG. 5. Three black regions which correspond to the position and size of the depressions 13.2 in the key bit 13.1 can be seen in the image. The memory means 31 is diagrammatically indicated at the bottom right in FIG. 5. In the example shown, the images (comparison values VW1 to VW3) of three keys were predefined in the initialization phase. In step C, the image 32.3 is compared with the stored comparison values VW1 to VW3. Since VW1 corresponds to the current actual value (image 32.3), release is effected, as indicated by the arrow 31.1.

However, the invention also functions with scanning means which generate the image (actual value) on a point-by-point basis or in steps. For example, it is possible to use a light-emitting diode or a laser which guides light onto the key bit 13.1, which light is then received by a detector after reflection. However, the functional principle remains the same.

In one particularly preferred embodiment, an algorithm which compares images or patterns is used.

The key recognition means 30 effect release by emitting an electrical pulse or by outputting a digital “1” or a digital “0”, for example. This pulse or this digital value can be recognized and processed further by another component of an elevator controller, for example.

The key recognition means 30 can be initialized. The initialization process can be carried out at the factory or in situ. Comparison values VW1-VW3 for one or more keys 13 are stored in the initialization phase. These comparison values VW1-VW3 are stored in the memory 31.

There are preferably possible ways of deleting or editing comparison values or of adding new comparison values. In order to protect these changes, a special authentication process may be provided. During authentication (in an authentication phase), a master key, for example, is scanned after being inserted into the key receptacle 16.2. The corresponding comparison value VW* for the master key can be stored in a protected memory area (which can be written to only once). It is possible to change to a modification mode (management mode) only when the image of the master key is recognized. However, it is also possible to enter the modification mode (management mode) by manually inputting a code via the control panel 10. Alternatively or additionally, it is possible to read a chip card in order to carry out an authentication process.

If the comparison values differ from the image in a defined tolerance range, the natural wear and tear or aging of the scanned key bit can be compensated for by adaptively correcting the comparison values without reducing the reliability and security of the system.

The invention provides numerous advantages which emerge from the description. The fact that the overall depth can be considerably smaller than in conventional key switches is particularly worth mentioning. In addition, the invention provides numerous possibilities for adaptation to the respective situation in situ. Further keys can simply be scanned and thus allowed. Keys which have been lost can simply be deleted from the memory.

It is also possible, without any problems, to register keys from different manufacturers and of different designs in the key recognition means 30 and thus to operate the key recognition means 30 using these keys. For example, a tenant of a building can register his garage key in order to operate an elevator using the garage key in future. Another resident in the same building can register and use his front door key, for example.

The solution shown is considerably more convenient and more flexible than previously known solutions since only one device can be used for a plurality of locking means/functions and not one locking cylinder for each function. Even self-manufactured keys can be detected and stored.

The level of security can be increased as desired if, for example in order to trigger a function, a plurality of keys have to be read in a determined (or undetermined) order. For example, release in order to reach the penthouse apartment: 1. car key=release, 2. apartment key=call input etc.

1. A key switch (15) for a drive device, having key recognition means for recognizing a key (13) with a key bit (13.1) and having a key receptacle (16.2) for inserting the key bit (13.1) into the key receptacle (16.2), characterized in that:
the key recognition means (30) comprises contactlessly operating scanning means (32) for scanning at least one part of the key bit (13.1) which has been inserted into the key receptacle (16.2), the scanning means (32) providing actual values for a key (13) which is currently inserted in the key receptacle (16.2),
memory means (31) are provided in order to store comparison values for a key (13) in an initialization phase,
an electronic comparator (33) is provided, which comparator compares actual values with comparison values and effects release if the actual values and comparison values match.

2. The key switch (15) as claimed in claim 1, characterized in that the scanning means (32) are arranged in the region of the key receptacle (16.2) and have at least one active window (16.4) in which the part of the key bit (13.1) which has been inserted into the key receptacle (16.2) can be scanned by the scanning means (32).

3. The key switch (15) as claimed in claim 1, characterized in that the scanning means (32) scan the part of the key bit (13.1) which has been inserted into the key receptacle (16.2) in steps.

4. The key switch (15) as claimed in claim 3, characterized in that an optical scanner is used as the scanning means (32).

5. The key switch (15) as claimed in claim 4, characterized in that the optical scanner comprises a light source, preferably a miniature laser, and a light detector.

6. The key switch (15) as claimed in claim 1, characterized in that the scanning means (32) record the part of the key bit (13.1) which has been inserted into the key receptacle (16.2) as a whole.

7. The key switch (15) as claimed in claim 6, characterized in that an optical CCD element is used as the scanning means (32).

8. The key switch (15) as claimed in claim 1, characterized in that it comprises a control panel (10) having at least one input means (2) and at least one display (3).

9. The key switch (15) as claimed in claim 8, characterized in that the key switch (15) can be converted, using the input means (2), into an initialization mode which detects comparison values for a key (13) and stores them in the memory means (31) in an initialization phase.

10. The key switch (15) as claimed in claim 1, characterized in that it is programmable, a change into a programming mode taking place only after an authentication phase.

11. The key switch (15) as claimed in claim 8, characterized in that a master key is inserted into the key receptacle (16.2) or a code is manually input via a control panel (10) during the authentication phase.

12. The key switch (15) as claimed in claim 1, characterized in that the memory means (31) are organized in such a manner that comparison values for a plurality of keys (13) can be stored, and in that the comparator (33) uses a number of stored comparison values to determine whether the actual values match one of the comparison values, for example with adaptive comparison value correction.

13. The key switch (15) as claimed in claim 1, characterized in that it is integrated in an elevator system or an escalator in order to trigger an action following release.

14. A method for operating a drive device using a key switch (15) having key recognition means (30) for recognizing a key (13) with a key bit (13.1) and having a key receptacle (16.2) for inserting the key bit (13.1) into the key receptacle (16.2), characterized by the following steps:
the key bit (13.1) of the key (13) is inserted into the key receptacle (16.2),
at least one part of the key bit (13.1) is contactlessly scanned and an actual value (32.3) is provided for the key (13) which is currently inserted in the key receptacle (16.2),
the actual value (32.3) is compared with one or more comparison values (VW1-VW3) which are stored in a memory (31),
release (31.1) is effected.

15. The method as claimed in claim 14, characterized in that the part of the key bit (13.1) is optically scanned using a scanning means (32), the scanning operation being carried out in steps or in one step.

16. The method as claimed in claim 14, characterized by the following step: the key recognition means (30) are initialized in an initialization phase, comparison values (VW1-VW3) for a key (13) being stored in this initialization phase.

17. The method as claimed in claim 14, characterized by the following step: a key (13) is authenticated in an authentication phase, either a master key being scanned and recognized after having been inserted into the key receptacle (16.2) or a code being manually input via a control panel (10) and the input being evaluated.
